(19) United States
(12) Patent Application Publication
(10) Pub. No.: US 2014/0195347 A1
(43) Pub. Date: Jul. 10, 2014

(54) METHOD, SYSTEM, AND COMPUTER PROGRAM PRODUCT FOR BUSINESS DESIGNATION

(71) Applicant: American Express Travel Related Services Company, Inc., New York, NY (US)

(72) Inventors: Urvi Adatia, Delhi (IN); Richa Awasthi, Haryana (IN); Manpreet Dhot, Edison, NJ (US); Amit Soni, Edison, NJ (US)

(21) Appl. No.: 13/929,376

(22) Filed: Jun. 27, 2013

Related U.S. Application Data
(60) Provisional application No. 61/750,170, filed on Jan. 8, 2013.

(51) Int. Cl. G06Q 30/02

(52) U.S. Cl. CPC G06Q 30/0255
USPC 705/14.53

(57) ABSTRACT

The present disclosure relates to a tool for identifying and designating a status indicator to a transaction account and/or transaction account holder. The system may be configured to collect data associated with a plurality of transaction accounts and perform a deterministic data analysis on the data to identify transaction accounts to associate with one of two groups. Also, the system may be configured to perform a probabilistic data analysis to create a probabilistic data analysis percentile score on at least one of the identified two groups to re-allocate the transaction accounts into one of the two groups. This re-allocation may be based on the probabilistic data analysis percentile score being above a predetermined threshold. The system may be configured to contact holders of the transaction accounts associated with at least one of the two groups.

### CROSS-REFERENCE TO RELATED APPLICATIONS

This application claims priority to, and the benefit of, U.S. Provisional Patent Application No. 61/750,170 filed Jan. 8, 2013 and entitled “METHOD, SYSTEM, AND COMPUTER PROGRAM PRODUCT FOR BUSINESS DESIGNATION,” which is hereby incorporated by reference in its entirety for all purposes.

### FIELD OP DISCLOSURE

The present disclosure generally relates to business designations. More particularly, the disclosure relates to methods, systems, and computer readable mediums for small business identification and associated products and/or services.

### BACKGROUND ART

Transaction accounts, such as credit cards, debit cards, gift cards etc., are widely used nowadays by consumers for different types of transactions. These transaction accounts are provided by financial institutions, such as banks, to consumers for transacting with merchants, service providers, and the like. Conventionally, transaction accounts may be broadly categorized into consumer transaction accounts and business transaction accounts. Consumer transaction accounts are provided to consumers employed by an employer. On the other hand, business transaction accounts (or corporate cards) may be given to business owners or employees of business entities or to business entities as a whole. The business owners or entities may use the business transaction accounts for transactions related to their respective businesses.

A financial institution, such as a bank, or a credit card service provider, may identify different types of customers in order to leverage financial benefits for the financial institution as well as the transaction account users. The different types of customers can include business owners, salaried employees, freelancers, and the like. The financial institution identifies the different types of customers and provides these customers with a suitable transaction account, such that the financial institution and the customers are equally benefited. Such identification may be beneficial for the financial institutions for improving their profit to loss ratio. Similarly, the customers are benefitted, in an example, by having the right reward policy associated with a suitable transaction account.

Generally, these financial institutions consider only a single variable while considering the type of transaction accounts to be given out to different consumers. However, in many cases, specifically for cases related to small business entities, single variable analysis is inadequate and often misleading. It is desirable to provide a method, system and/or apparatus that addresses these and other unmet needs.

### SUMMARY OF THE DISCLOSURE

The present disclosure improves upon existing systems and methods by providing a tool for identifying and designating a status indicator to a transaction account and/or transaction account holder. For instance, the status indicator may indicate that the holder has an associated number of employees under (or above) a predetermined threshold and/or an amount of revenue, such as annual revenue, below (or above) a pre-set threshold, such as would be had by a small business.

In various embodiments, the system is configured to collect data associated with a plurality of transaction accounts. The system performs a deterministic data analysis on the data to identify transaction accounts to associate with one of two groups. The system may be configured to perform a probabilistic data analysis to create a probabilistic data analysis percentile score on at least one of the identified two groups to re-allocate the transaction accounts into one of the two groups. This re-allocation may be based on the probabilistic data analysis percentile score being above a predetermined threshold. The system may also be configured to contact holders of the transaction accounts associated with at least one of the two groups.

In various embodiments, one of the groups comprises a group of businesses having both less than a preselected number of employees and/or less than preselected annual revenue. In various embodiments, the system is configured to exclude small business entities from one of the groups. In various embodiments, the deterministic data may comprise the transaction account holder indicating a number of employees that work for the transaction account holder's company, wherein the number of employees is more than a first preset threshold of employees and less than a second preset threshold of employees. In various embodiments, the deterministic data may comprise a company's revenue being less than a preset threshold of dollars. In various embodiments, the deterministic data may comprise a company's revenue being more than a preset threshold of dollars. In various embodiments, the probabilistic data may comprise a weighted percentage assigned based on an email domain associated with a transaction account holder which is a domain used by a lower than a preset threshold of email domains. In various embodiments, the probabilistic data comprises a weighted percentage assigned based on an email domain associated with a transaction account holder which is not associated with a gmail.com, yahoo.com, hotmail.com, aol.com, msn.com, comcast.com, cox.net, Verizon.net, and sbcglobal.net.

The probabilistic data may comprise at least one of online activity, number of supplementary transaction instruments, inquiries from the consumer bureau, and demographic data. In various embodiments, the probabilistic data and/or the deterministic data may be collected from at least one of online browsing behavior on a transaction account issuer website, transaction account application, transaction account holder website, polling the transaction account holder, credit bureau, a transaction account issuer, transaction account and a transaction processor. The probabilistic data may comprise a record stored by a credit bureau of a point of sale system being installed at a location associated with the holder of the transaction account.

In various embodiments, the probabilistic data variables are each assigned an independent weighted percentile which contribute to the probabilistic data analysis percentile score and indicate likelihood of group membership. In various embodiments, the allocating the transaction accounts into one of the two groups is based on the percentage likelihood being above a preset threshold. The computer-based system may be configured to target the members of one of the groups for a risk treatment based on the designation. In various embodiments, the members of at least one of groups are contacted to at least one of change the reward attributes of their transaction account. In various embodiments, the computer-based system may be configured to associate the transaction accounts associated with the designation allocated to the transaction account holders to at least one of the two groups. In various embodiments, the computer-based system may be configured to re-allocate the transaction accounts associated with the designation allocated to the transaction account holder to at least one of the two groups. In various embodiments, the computer-based system may be configured to assign the business designation to transaction account holders of the groups.

### BRIEF DESCRIPTION OP THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 illustrates components of a business designation system, in accordance with various embodiments;

FIG. 2 illustrates a process flow for business designation, in accordance with various embodiments; and

FIG. 3 illustrates a block diagram of an exemplary computer system for implementing the present disclosure, in accordance with various embodiments.

### DETAILED DESCRIPTION

In general, the present disclosure relates to method, system, and an article of manufacture for business designation. A business designation system may perform deterministic and probabilistic data analysis on data related to a plurality of transaction accounts in order to associate the transaction accounts with one of two groups. The business designation system may create a probabilistic data analysis score, compare the probabilistic data analysis score to a pre-defined threshold and re-allocate the transaction accounts into one of the two groups based on the probabilistic data analysis score being above the threshold. In one example, the two groups may include a small business (SB) group or a consumer card servicing (CCS) group. The SB group may include transaction accounts of consumers owning and/or being associated with one or more small businesses. The small businesses may be defined as businesses having not more than a pre-defined number of employees and/or pre-defined annual revenue. The CCS group may include transaction accounts of individual consumers not owning and/or being associated with small businesses. According to various embodiments, the business designation system may designate transaction accounts having a probabilistic data analysis score of more than 75% as SB group transaction accounts. The business designation system may then contact the transaction account holders associated with at least one of the two groups. For example, the business designation system may contact the transaction account holders assigned to the SB group to offer transaction account more suitable to needs of small businesses. In other example, the business designation system may contact the transaction account holders assigned to the SB group to advertise relevant products.

The detailed description of exemplary embodiments of the present disclosure herein makes reference to the accompanying drawings and figures, which show the exemplary embodiments by way of illustration only. While these exemplary embodiments are described in sufficient detail to enable those skilled in the art to practice the present disclosure, it should be understood that other embodiments may be realized and that logical and mechanical changes may be made without departing from the spirit and scope of the present disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

The present disclosure is now described in terms of an exemplary system in which the present disclosure, in various embodiments may be implemented. This is for convenience only and is not intended to limit the application of the present disclosure. It will be apparent to one skilled in the relevant art(s) how to implement the present disclosure in alternative embodiments.

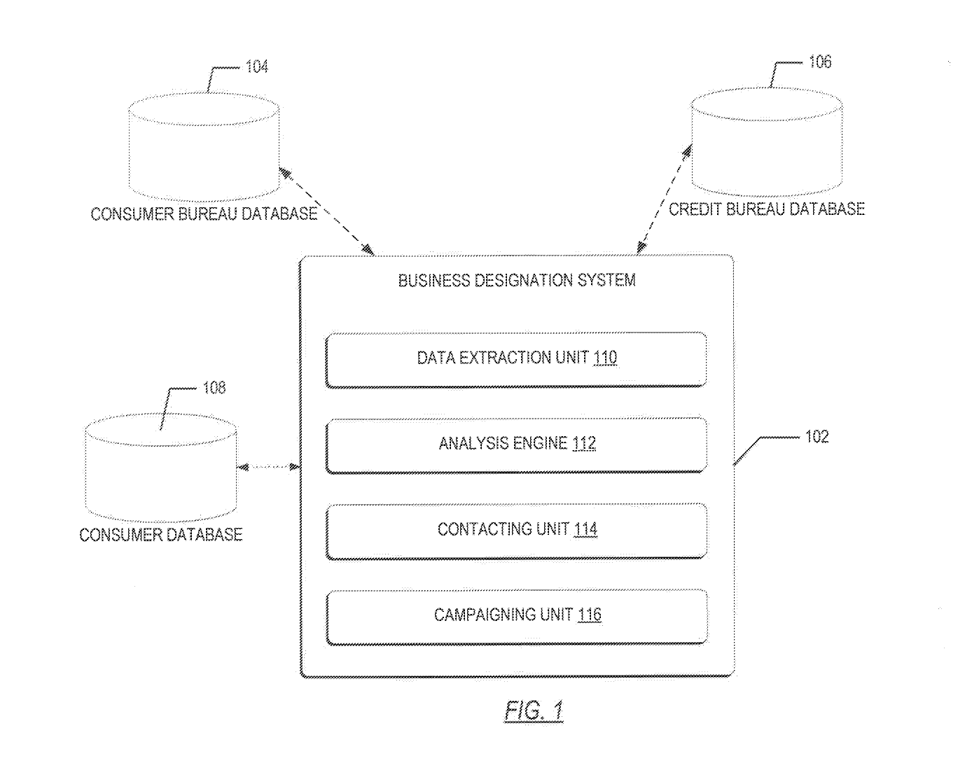

FIG. 1 illustrates various components of a business designation system 102. Business designation system 102 may collect data associated with a plurality of transaction accounts. Business designation system 102 may perform deterministic data analysis on the collected data and allocate the plurality of transaction accounts to one of two groups. In an example, the two groups may include the SB group and the CCS group. However, according to various embodiments, the plurality of transaction accounts may also be allocated to groups other than the SB group and the CCS group. In various embodiments, business designation system 102 may also re-allocate the plurality of transaction accounts into one of the two groups based on probabilistic data analysis of the collected data. The SB group may include transaction accounts of consumers owning or being associated with one or more small businesses. The small businesses may be defined as businesses having not more than a predefined number of employees and/or pre-defined annual revenue. The CCS group may include transaction accounts of individual consumers not owning or being associated with small businesses.

As depicted in FIG. 1, business designation system 102 may be communicatively coupled to a plurality of databases such as consumer bureau database 104, credit bureau database 106 and consumer database 108. Business designation system 102 may collect relevant data associated with one or more transaction accounts from these databases and apply deterministic and/or probabilistic data analysis on the collected data for allocating or re-allocating the one or more transaction accounts to the SB group or the CCS group.

Consumer bureau database 104 may be a database deployed by a consumer bureau and may have information about one or more consumers registered with the consumer bureau. Consumer bureau database 104 may store information associated with creditors, lenders, utilities, debt collection agencies and the like that the consumers are related to. This information may include loan information, employment information, annual income information, and the like associated with the consumers. For example, consumer bureau database 104 may have information related to commercial inquiries, such as inquiries about point of sale (POS) terminals, commercial land leasing, permits for commercial activities, etc., made by a plurality of consumers. In another example, consumer bureau database 104 may have information stated in transaction account applications by different consumers. Such information may include name of a consumer, occupation of the consumer, name of the consumer's employer, and the like. Consumer bureau database 104 may further include information related to e-mail domains of consumers. Consumers may have e-mail accounts either on public e-mail domains such as Yahoo®, MSN®, Hotmail®, etc. (e.g. bobjones@yahoo.com), or on a unique consumer specific e-mail domains (e.g. CEO@newsweekly.org). Thus, predominantly used domains do not provide much information. However, the domains that are less owned/used, which are more unique, provide an inference that the user is associated with a small business. The unique consumer specific e-mail domains may be personalized and/or private e-mail domains created by consumers for private mail communication such as for self-owned businesses. For example, a consumer (“David Smith”), owning an ice-cream parlor (e.g. “Yummy Ice Creams”), may create a website (www.YummyIceCreams.com) for advertising various products of the ice-cream parlor and also create a unique e-mail domain (davidsmith@yummyicecreams.com) to receive feedbacks and comments from customers and send replies back to the customers. In an example implementation, a unique e-mail domain may be used by a fixed number of users such that the number of users is less than a preset threshold value. Such as, for example, less than the number of users having a Yahoo or a Hotmail domain/account. Consumer bureau database 104 may also store information associated with a transaction account holder website. Referring to the above example, the consumer bureau database 104 may store information pertaining to annual turnover and number of employees of “Yummy Ice Creams” from its website, i.e., www.YummyIceCreams.com.

Credit bureau database 106 may store information related to listings of different businesses, list of board of directors and major personnel associated with the businesses, annual revenues of the businesses, and the like. For example, credit bureau database 106 may have stored specific information about a business entity such as name of the business entity, type of business, annual turnover of the business entity, stock prices of the business entity, and the like. In another example, credit bureau database 106 may have information associated with one or more businesses listed in various financial record keeping companies such as Cortera Pulse™, Dun & Bradstreet™, LexisNexis® Accurint®, Experian, and the like. Thus, credit bureau database 106 may have accumulated information associated with various businesses and respective listings of these businesses acquired from one or more financial record keeping companies. In another example, credit bureau database 106 may further store information related to one or more transaction processors associated with a consumer. The transaction processor may include payment gateways, online banking service providers, and the like. Credit Bureau database 106, and/or a portion thereof, may be replicated as an internal database. Information related to the one or more transaction processors may include online transaction details such as online purchasing and selling associated with the consumer. In another example, credit bureau database 106 may also store information associated with one or more transaction accounts of a consumer. The information associated with the one or more transaction accounts of the consumer may be retrieved from a financial institution that issues the one or more transaction accounts to the user. Such information may include debit and credit information, outstanding dues information, recent billing information and the like associated with the consumer.

As depicted in FIG. 1, business designation system 102 may be communicatively coupled to consumer database 108. Consumer database 108 may store financial and/or demographic information associated with one or more consumers. The financial and demographic information of a consumer, may include data related to location of the consumer, number of transaction accounts held by the consumer, annual card spend of the consumer, remittance information associated with the consumer, and the like. For example, consumer database 108 may also store information related to number of commercial businesses running in a vicinity of the consumer's location, number of business transaction account holders in the vicinity of the consumer's location, and the like. Consumer database 108 may also store information about online behavior of the consumers. Online behavior of a consumer may refer to frequency of visits of the consumer, on websites and portals of financial institutions, offering business transaction accounts. For example, consumer database 108 may store information related to number of times a consumer has visited a webpage of a bank's website that displays details of business transaction accounts on offer. In addition, consumer database 108 may further store information about the transaction account application and may include information provided by a consumer in a transaction account application. Such information may include, for example, name of the consumer, consumer address, business information (revenue, business location, number of employees, type of the business, etc.), billing address and/or the like. In another example, the consumer database 106 may store information retrieved from polling a transaction account holder. The transaction account holder may be polled, in an example, through online and/or physical surveys. Such information may include consumer information, such as investment details, monthly spending information, information associated with other income sources and the like for the transaction account holder. In one embodiment, consumer database 108 may be deployed by the same entity deploying business designation system 102. Alternatively, consumer database 108 may be deployed by a third party as a service.

Business designation system 102 may extract relevant data associated with consumers associated with the plurality of transaction accounts, from the consumer bureau database 104, credit bureau database 106, and the consumer database 108 and analyze the extracted data for grouping transaction accounts, associated with the consumers, into the SB group and the CCS group. Referring back to FIG. 1, business designation system may include a data extraction unit 110, an analysis engine 112, a contacting unit 114, and a campaigning unit 116.

Data extraction unit 110 collects data from the databases communicatively coupled to business designation system 102. Data extraction unit 110 may extract relevant data associated with the consumers from these databases. In an example, data extraction unit 110 may extract data associated with employment information of the consumers, recent commercial inquiries by the consumers, e-mail domains of the consumers, and the like from consumer bureau database 104. In an example, data extraction unit 110 may extract information related to listed businesses of consumers, business revenue information of the consumers, details about employees and board of directors associated with a business of a consumer, and the like from credit bureau database 106. In an example, data extraction unit 110 may extract other information such as number of supplementary cards owned by a consumer, location of the consumer, details of registered businesses running in a vicinity of the consumer, and the like from consumer database 108.

Analysis engine 112 analyzes the collected data. Analysis engine 112 may analyze the collected data associated with a plurality of transaction accounts. According to various embodiments, analysis engine 112 may analyze the collected data by performing deterministic data analysis and/or probabilistic data analysis. Analysis engine 112 may perform the deterministic analysis based upon one or more deterministic variables. Analysis engine 112 may perform the probabilistic analysis based upon one or more probabilistic variables. The collected data may include data pertaining to the one or more deterministic variables and/or the one or more probabilistic variables. According to various embodiments, transaction accounts, associated with deterministic variables, may be directly allocated to the SB group. According to various embodiments, transaction accounts, associated with the probabilistic variables, may be allocated, either to the CCS or the SB group, based on a probabilistic data analysis score.

Deterministic variables may be variables that suggest, in a substantially deterministic manner, that a particular transaction account can be associated with a small business. The deterministic variables may be based on deterministic data related to one or more consumers. In an example, the deterministic data may include data suggesting that a consumer, associated with the transaction account, is a registered small business owner and/or associated with a small business. The consumer, for example, may be an owner of a small business entity and/or associated with a small business, registered with a credit bureau and having number of employees more than a first preset threshold and less than a second preset threshold. In another example, the deterministic data may include data suggesting that a consumer is an authorized officer, for example, a director, a president, a chairperson, a chief executing officer (CEO), a chief operating officer (COO), a principal, an owner, etc., of a small business entity. Further, data associated with business entities having annual revenue and number of employees more than a preset threshold, may also be included in the deterministic data. In another example, for a particular financial institution, data depicting that a consumer already has an active merchant relationship with the financial institution, may be included in the deterministic data. In yet another example, the deterministic data may include data suggesting that a consumer is an existing but unregistered small business owner and/or associated with a small business. In such cases, the small business entity may have existing SE or GCC linkages or the consumer owning the small business entity may have government contracts registered to his name. Analysis engine 112 may analyze the deterministic variables based on the deterministic data analysis. In one example, deterministic data analysis may include assigning fixed deterministic scores to all transaction accounts fulfilling a deterministic variable criterion. That is, for all transaction accounts satisfying any one of the deterministic variable criteria, the deterministic score may be set to 1. For all other transaction accounts the deterministic score may be equal to 0.

For example, analysis engine 112 may check whether any of the transaction accounts are associated an owner have an active merchant relationship with the transaction account issuer. Analysis engine 112 may assign a deterministic score of 1 to such transaction accounts, thereby indicating that these transaction accounts can be grouped into the SB group. In another example, analysis engine 112 may check whether any of the transaction accounts are associated with an authorized officer of businesses and may retrieve details, such as, number of employees, amount of annual turnover, Small Business Financial Exchange (SBFE) registration, and the like for these businesses. These details may be compared with one or more criteria, and based upon the comparison; analysis engine 112 may assign transaction accounts satisfying the one or more criteria, a deterministic score of 1 and group these transaction accounts into the SB group. For example, analysis engine 112 may group a transaction account associated with a business entity having the number of employees less than or equal to a first threshold, for example, 250 and/or the annual revenue less than or equal to a second threshold, for example, 10 million dollars, into the SB group. In other example, analysis engine 112 may group a transaction account into the SB group if the associated business is registered with SBFE.

According to various embodiments, analysis engine 112 may apply probabilistic data analysis on the probabilistic variables and assign a probabilistic data analysis score to the transaction accounts. Analysis engine 112 may exclude from the probabilistic data analysis those transaction accounts having the deterministic score of 1 assigned based upon the deterministic data analysis. Analysis engine 112 may group the transaction accounts based on whether the probabilistic data analysis score is more or less than a threshold. In an example, analysis engine 112 may group transaction accounts having a probabilistic data analysis score more than a given threshold into the SB group and all other transaction accounts into the CCS group. The threshold may be defined by a financial institution implementing business designation system 102 and may be configured within business designation system 102.

Examples of the probabilistic variables for a consumer may include commercial inquiries and/or queries (such as commercial land leasing inquiry, point of sale instrument inquiry etc.), an e-mail domain, type and amount of card spend, remittances through business checks, online behavior, small business entities running in a vicinity of the consumer location, number of supplementary cards, demographic data and/or the like. In an example, the probabilistic variables may include records of POS systems installed at one or more consumer locations. In another example, the probabilistic variables may include online activity of a consumer. The online activity of a consumer may refer to how frequently the consumer visits a website of a financial institute for looking up offers and other details related to small business transaction accounts on offer by the financial information.

Analysis engine 112 may assign each of the probabilistic variables an independent weighted percentage score. The independent weighted percentage score of a probabilistic variable may be indicative of statistical significance of the probabilistic variable in the overall probabilistic data analysis score. Further, the independent weighted percentage score of probabilistic variable may indicate likelihood of the transaction accounts, associated with the probabilistic variable, being allocated to the SB group. In an example, an independent weighted percentage score may be assigned based on an e-mail domain associated with a transaction account holder, if the e-mail domain is used by less than a preset threshold number of e-mail users. As described earlier, such an e-mail domain may be categorized under a unique e-mail domain category. The unique e-mail domain category may include e-mail domains not associated with well-known e-mail domains such as yahoo.com, gmail.com, Hotmail.com, aol.com, msn.com, Comcast.com, cox.net, Verizon.net, sbcglobal.net and/or the like. According to various embodiments, analysis engine 112 may assign each of the probabilistic variables their independent weighted percentage score based on a multi-variable regression analysis on the probabilistic variables. Other conventional probabilistic or statistical techniques may also be used.

According to various embodiments, analysis engine 112 may perform the probabilistic analysis using multi-variable regression. Analysis engine 112 may use the following mathematical expression for performing the multi variable regression.

Yᵢ=f(Xᵢ, μᵢ), i=1 to n (1)

In the above equation, symbols Y₁, Y₂ . . . Yₙ denote dependent variables and β₁, β₂ . . . βₙ denote parameters (here, independent weightage percentages) of the regression. Further, X₁, X₂ . . . Xₙ in equation (1) denote independent variables.

In the probabilistic analysis, the independent variables may correspond to probabilistic variables. Analysis engine 112 may assign values to the independent variables depending upon the collected data pertaining to the probabilistic variables. In an example, the independent variable X₁ may correspond to remittance information associated with a transaction account. In another example, independent variable X₂ may correspond to a yearly transaction account spend of a consumer. Thus, each independent variable may correspond to each probabilistic variable associated with a transaction account. Further, analysis engine 112 may assign values, between 0 and 1, to the independent variables depending upon values of the corresponding probabilistic variables. For example, X₁ may be set to 0 if amount of remittance from business checks is less than $10,000 per month, and X₁ may be set to 1 if the amount of remittance from business checks is greater than or equal to $10,000. In another example, X₁ may be set to 0 if amount of remittance from business checks is less than or equal to $2,000 per month, 0.5 if it is between $2,000 and $8,000 per month, and 1 if it is greater than or equal to $8,000 per month. Further, if the number of supplementary transaction instruments (cards) is zero, the independent variable associated with the number of supplementary transaction instruments may be assigned a value of 0. Similarly, if the number of supplementary transaction instruments is 1 or 2, the independent variable may be assigned a value of 0.5 and for the number of supplementary transaction instruments being greater than 2; the independent variable may be assigned a value of 1. Similarly, in an example, if the user makes a commercial inquiry from a credit bureau, such as an inquiry for leasing a commercial land, the independent variable associated with commercial inquiries may be assigned a value 1 and 0 if no such inquiry is made. The values for the independent variables corresponding to other probabilistic variables may be suitably assigned in a similar manner.

The parameters may be estimated by applying the regression analysis to transaction accounts that are grouped into the SB group using the deterministic analysis. In this case, the dependent variables may be set to 1 for transaction accounts having a deterministic score of 1. Further, the values of all the independent variables associated with such transaction accounts may be fed into equation (1) and the values of unknown parameters may be determined. The values of the unknown parameters may provide for the independent weightages of the probabilistic variables. Referring to the above example of independent variable X₁ being associated with remittance information, the value of β₁ may give the independent percentage weight of the probabilistic variable associated with the remittance information. Similarly, the value of β₂ may give the independent weighted percentage of the probabilistic variable associated with annual card spend of a consumer, and so on. Thus, the independent percentage weight of each probabilistic value may be determined.

Once the independent percentage weight of each probabilistic variable is determined, analysis engine 112 may calculate the overall probabilistic data analysis score using regression analysis for transaction accounts undergoing the probabilistic analysis. The overall probabilistic data analysis score may refer to a cumulative percentage score given to a transaction account for allocating the transaction account to the SB group or to the CCS group. A threshold percentage value may be pre-defined and stored within business designation system 102, and all transaction accounts, having the probabilistic data analysis score greater than the pre-defined threshold percentage value may be allocated to the SB group. All other transaction accounts may be allocated to the CCS group. For example, analysis engine 112 may allocate all transaction accounts having a probabilistic data analysis score greater than or equal to 80%, to the SB group and all other transaction accounts to the CCS group. Further, analysis engine 112 may also designate holders of the transaction accounts, allocated to the SB group, as Small Business group members.

In response to transaction accounts being allocated to the SB group and the CCS group, contacting unit 114 may contact holders of the transaction accounts, i.e. designated small business group members. Contacting unit 114 may contact the small business group members for making offers for transaction accounts that are more suitable for small businesses. In an example, contacting unit 114 may send an e-mail to a designated small business group member stating that the designated small business group member is eligible for an SB transaction account. The e-mail may also include details such as SB transaction account policy, corresponding benefits, terms and conditions, and the like.

According to various embodiments, contacting unit 114 may also contact one or more of the designated small business group members for upgrading their consumer transaction accounts to SB transaction accounts. The upgrade may happen for the transaction accounts re-allocated from the CCS group to the SB group. For example, contacting unit 114 may transmit correspondence to the designated small business group member, offering to upgrade a reward policy of the designated small business owner's consumer transaction account, to that of the SB transaction account reward policy.

Business designation system 102 may also be deployed to design a campaigning process, in order to target holders of transaction accounts associated with one or more groups, for example, small business group members to promote various products, services and/or promotional offers. Campaigning unit 116 of business designation unit 102 may create a campaign based, at least in part, on the allocation/re-allocation of the transaction accounts to one or more groups, for example, the SB group and the CCS group. Campaigning unit 116 may identify suitable products and/or offers targeting one of the groups, such as, the SB group and contact the small business group members as part of the campaign. Campaigning unit 116 may send different promotional material via e-mails, mails, instant messages, text messages and/or the like, to different small business group members based on a plurality of factors. The plurality of factors may include the probabilistic data analysis score, customer loyalty, personal or demographic information of the small business group members, business revenue, and the like. The promotional offers may include new transaction account memberships, low-interest loan schemes, add-on transaction accounts, club memberships, holiday packages, financial services and the like. For example, campaigning unit 116 may send a promotional e-mail, regarding a low-interest loan scheme, to a small business group member having a probabilistic data analysis score of 90% and having a transaction account operating for more than two years. In another example, campaigning unit 116 may send a promotional e-mail to a small business group member regarding add-on card membership, based on the small business group member's annual card spend through an existing SB card.

In yet another embodiment, business designation system 102 may also be used to profile transaction accounts for risk management. In this case, business designation system 102 may allocate the transaction accounts into one of three groups, namely, high, medium and low, according to financial risks associated with respective transaction accounts, for example. This may help the transaction account issuer or any other financial institution deploying business designation system 102 to mitigate risks. For example, different credit limit rules may be applied to transaction account holders in different groups. Other types of grouping, for example, a small business group member, a consumer card owner and a large business owner, are also contemplated herein.

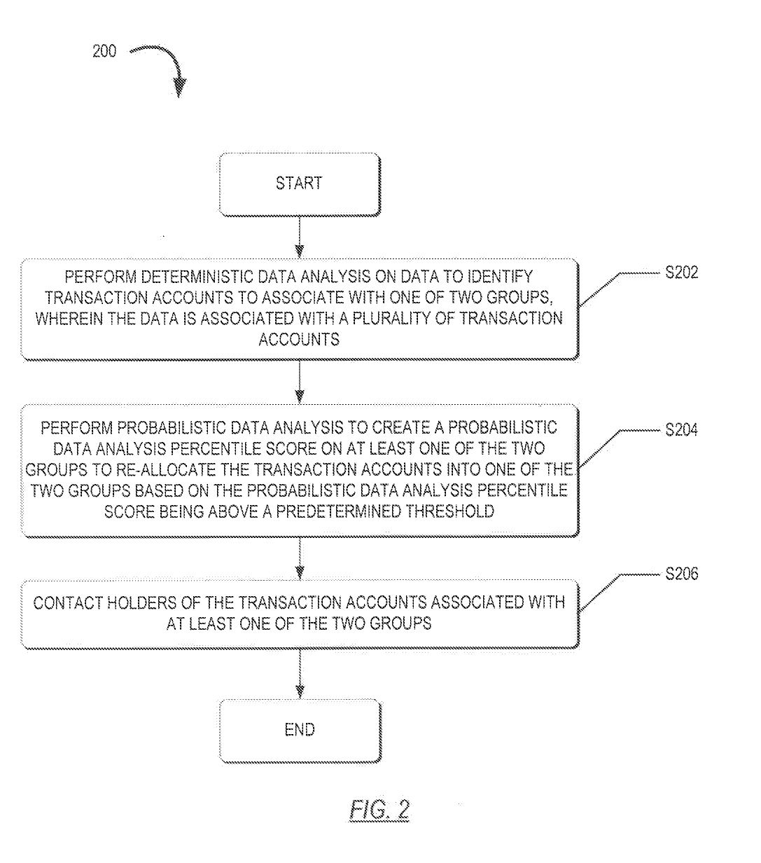

FIG. 2 illustrates a flowchart of an example process 200 for allocating a plurality of transaction accounts to one of the two groups, i.e., the SB group or the CCS group. In various alternate embodiments, the plurality of transaction accounts may also be allocated to other groups such as large business owners, individual transaction account holders and the like. Further, in additional embodiments, a plurality of transaction accounts can also be grouped into more than two groups.

Process 200 starts at step S202, where the business designation system 102 performs deterministic data analysis on data associated with transaction accounts for identifying transaction accounts to associating with one of two groups, for example, the SB group or the CCS group. In an example, the data associated with the transaction account may be extracted from any one of databases, such as, consumer bureau database 104, credit bureau database 106, and/or the consumer database 108. As described in foregoing, the deterministic data analysis may be done on one or more deterministic variables.

At step S204, probabilistic data analysis is performed to create a probabilistic data analysis score. The probabilistic data analysis may be done on one or more probabilistic variables. Each probabilistic variable may be assigned an independent weighted percentage. As described earlier, the independent weighted percentages may be estimated by using the deterministic scores as dependent variables in the regression analysis.

The independent weighted percentages of the probabilistic variables are used to calculate the probabilistic data analysis score for the transaction accounts. The probabilistic data analysis score may be calculated using regression analysis. Based on the probabilistic data analysis score being above or below a threshold, the transaction accounts may be allocated to one of the two groups.

At step S206, transaction account holders of the transaction accounts allocated to at least one of the two groups, are contacted. In one example, where the two groups are the SB group and the CCS group, the holders of the transaction accounts allocated to the SB group may be contacted to offer SB transaction accounts. Further, holders of the transaction accounts, re-allocated from the CCS group to the SB group, may be contacted regarding upgrading their consumer transaction accounts to the SB transaction accounts. The transaction account holders may be contacted, in an example, by sending an e-mail, a mail, a text message, an instant message and/or the like. In another example, customer care executives of a financial institution implementing business designation system 102 may personally contact the holders of the transaction accounts allocated to the SB group. Further, according to various embodiments, business designation system 102 may assign business designations to one or more transaction account holders based on grouping of the transaction accounts into one or more groups. For example, business designation system 102 may designate holders of transaction accounts, allocated to the SB group, as small business owners.

The present disclosure (i.e., system 100, process 200, or any part(s) or function(s) thereof) may be implemented using hardware, software or a combination thereof, and may be implemented in one or more computer systems or other processing systems. However, the manipulations performed by the present disclosure were often referred to in terms, such as comparing or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

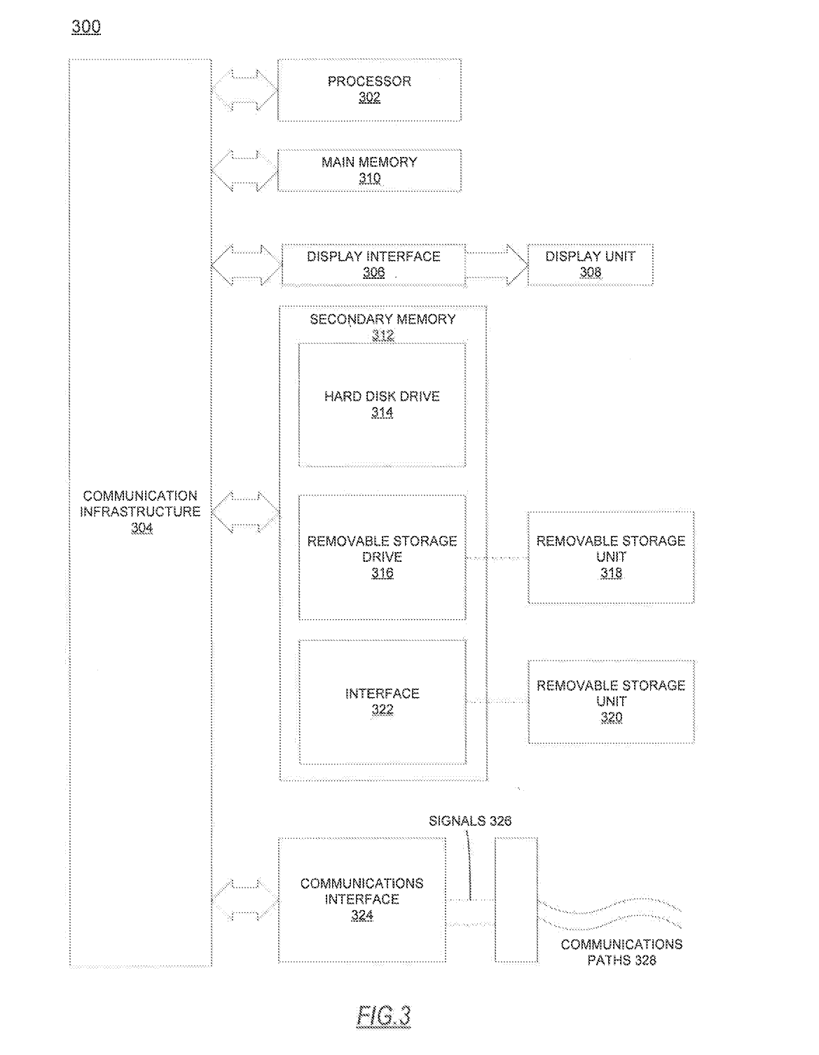

In fact, in accordance with various embodiments of the present disclosure, the present disclosure is directed towards one or more computer systems capable of carrying out the functionality described herein. An example of the computer systems includes a computer system 300, which is shown in FIG. 3.

The computer system 300 includes at least one processor, such as a processor 302. Processor 302 is connected to a communication infrastructure 304, for example, a communications bus, a cross over bar, a network, and the like. Various software embodiments are described in terms of this exemplary computer system 300. After reading this description, it will become apparent to a person skilled in the relevant art(s) how to implement the present disclosure using other computer systems and/or architectures.

The computer system 300 includes a display interface 306 that forwards graphics, text, and other data from the communication infrastructure 304 (or from a frame buffer which is not shown in FIG. 3) for display on a display unit 308.

The computer system 300 further includes a main memory 310, such as random access memory (RAM), and may also include a secondary memory 312. The secondary memory 312 may further include, for example, a hard disk drive 314 and/or a removable storage drive 316, representing a floppy disk drive, a magnetic tape drive, an optical disk drive, etc. The removable storage drive 316 reads from and/or writes to a removable storage unit 318 in a well-known manner. The removable storage unit 318 may represent a floppy disk, magnetic tape or an optical disk, and may be read by and written on by the removable storage drive 316. As will be appreciated, the removable storage unit 318 includes a computer usable storage medium having stored therein, computer software and/or data.

In accordance with various embodiments of the present disclosure, the secondary memory 312 may include other similar devices for allowing computer programs or other instructions to be loaded into the computer system 300. Such devices may include, for example, a removable storage unit 320, and an interface 322. Examples of such devices may include a program cartridge and cartridge interface (such as that found in video game devices), a removable memory chip (such as an erasable programmable read only memory (EPROM), or programmable read only memory (PROM)) and associated socket, and other removable storage units 320 and interfaces 322, which allow software and data to be transferred from the removable storage unit 320 to the computer system 300.

The computer system 300 may further include a communication interface 324. The communication interface 324 allows software and data to be transferred between the computer system 300 and external devices. Examples of the communication interface 324 include, but may not be limited to a modem, a network interface (such as an Ethernet card), a communications port, a Personal Computer Memory Card International Association (PCMCIA) slot and card, and the like. Software and data transferred via the communication interface 324 are in the form of a plurality of signals, hereinafter referred to as signals 326, which may be electronic, electromagnetic, optical or other signals capable of being received by the communication interface 324. The signals 326 are provided to the communication interface 324 via a communication path (e.g., channel) 328. The communication path 328 carries the signals 326 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 316, a hard disk installed in hard disk drive 314, the signals 326, and the like. These computer program products provide software to the computer system 300. The present disclosure is directed to such computer program products.

Computer programs (also referred to as computer control logic) are stored in the main memory 310 and/or the secondary memory 312. Computer programs may also be received via the communication interface 304. Such computer programs, when executed, enable the computer system 300 to perform the features of the present disclosure, as discussed herein. In particular, the computer programs, when executed, enable the processor 302 to perform the features of the present disclosure. Accordingly, such computer programs represent controllers of the computer system 300.

In accordance with various embodiments of the present disclosure, where the present disclosure is implemented using a software, the software may be stored in a computer program product and loaded into the computer system 300 using the removable storage drive 316, the hard disk drive 314 or the communication interface 324. The control logic (software), when executed by the processor 302, causes the processor 302 to perform the functions of the present disclosure as described herein.

According to various embodiments, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

The various embodiments of the present disclosure have been described above, it should be understood that they have been presented by way of example, and not limitation. It will be apparent to persons skilled in the relevant art(s) that various changes in form and detail can be made therein without departing from the spirit and scope of the present disclosure. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the present disclosure, are presented for example purposes only. The architecture of the present disclosure is sufficiently flexible and configurable, such that it may be utilized (and navigated) in ways other than that shown in the accompanying figures.

The present disclosure is described herein with reference to system architecture, block diagrams and flowchart illustrations of methods, and computer program products according to various aspects of the present disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsee, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybox 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client side scripting language, such as JavaScript, VBScript or the like. For a basic introduction of cryptography and network security, see any of the following references: (1) “Applied Cryptography: Protocols, Algorithms, And Source Code In C,” by Bruce Schreier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, internet based embodiments, entirely hardware embodiments, or embodiments combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 1-2 the process flows and screenshots depicted are merely embodiments and are not intended to limit the scope of the disclosure. For example, the steps recited in any of the method or process descriptions may be executed in any order and are not limited to the order presented.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method comprising:
performing, by a business designation computer-based system, deterministic data analysis on data to identify transaction accounts to associate with one of two groups, wherein the data is associated with a plurality of transaction accounts;
performing, by the computer-based system, probabilistic data analysis to create a probabilistic data analysis score on at least one of the two groups to re-allocate the transaction accounts into one of the two groups based on the probabilistic data analysis score being above a predetermined threshold; and
contacting, by the computer-based system, holders of the transaction accounts associated with at least one of the two groups.

2. The method of claim 1, wherein one of the groups comprises a group of businesses having both less than a preselected number of employees and less than a preselected annual revenue.

3. The method of claim 1, wherein one of the groups excludes small business entities.

4. The method of claim 1, wherein the deterministic data comprises the transaction account holder indicating a number of employees that work for the transaction account holder's company, wherein the number of employees is more than a first preset threshold of employees and less than a second preset threshold of employees.

5. The method of claim 1, wherein the deterministic data comprises revenue being less than a preset threshold of dollars.

6. The method of claim 1, wherein the deterministic data comprises revenue being more than a preset threshold of dollars.

7. The method of claim 1, wherein the probabilistic data comprises a weighted percentage assigned based on an email domain associated with a transaction account holder which is a domain used by a lower than a preset threshold of all email users.

8. The method of claim 1, wherein the probabilistic data comprises a weighted percentage assigned based on an email domain associated with a transaction account holder which is not associated with gmail.com, yahoo.com, hotmail.com, aol.com, msn.com, comcast.com, cox.net, Verizon.net, and sbcglobal.net.

9. The method of claim 1, wherein the probabilistic data comprises at least one of online activity, number of supplementary transaction instruments, inquiries from a consumer bureau, and demographic data.

10. The method of claim 1, wherein at least one of the deterministic data and probabilistic data is collected from at least one of online browsing behavior on a transaction account issuer website, transaction account application, transaction account holder website, polling the transaction account holder, credit bureau, a transaction account issuer, transaction account and a transaction processor.

11. The method of claim 1, wherein the probabilistic data comprises a record stored by a credit bureau of a point of sale system being installed at a location associated with the holder of the transaction account.

12. The method of claim 1, wherein probabilistic variables based on the probabilistic data are each assigned an independent weighted percentage which contribute to the probabilistic data analysis score and indicate likelihood of group membership.

13. The method of claim 1, further comprising allocating the transaction accounts into one of the two groups is based on the probabilistic data analysis score being above a preset threshold.

14. The method of claim 1, further comprising targeting, by the computer-based system, members of one of the groups for a risk treatment based on group membership.

15. The method of claim 1, wherein members of at least one of groups are contacted to at least one of change the reward attributes of their transaction account.

16. The method of claim 1, further comprising associating the transaction accounts to at least one of the two groups.

17. The method of claim 1, further comprising re-allocating the transaction accounts to at least one of the two groups.

18. The method of claim 1, further comprising assigning the business designation to the holders of the transaction accounts of the groups.

19. A system comprising:
a business designation processor,
a tangible, non-transitory memory configured to communicate with the processor,
the tangible, non-transitory memory having instructions stored thereon that, in response to execution by the processor, causes the processor to perform operations comprising:
performing, by the processor, deterministic data analysis on data to identify transaction accounts to associate with one of two groups, wherein the data is associated with a plurality of transaction accounts;
performing, by the processor, probabilistic data analysis to create a probabilistic data analysis score on at least one of the two groups to re-allocate the transaction accounts into one of the two groups based on the probabilistic data analysis score being above a predetermined threshold; and
contacting, by the processor, the holders of the transaction accounts associated with at least one of the two groups.

20. An article of manufacture including a non-transitory, tangible computer readable storage medium having instructions stored thereon that, in response to execution by a business designation computer-based system, cause the computer-based system to perform operations comprising:
performing, by the computer-based system, deterministic data analysis on data to identify transaction accounts to associate with one of two groups, wherein the data is associated with a plurality of transaction accounts;
performing, by the computer-based system, probabilistic data analysis to create a probabilistic data analysis score on at least one of the two groups to re-allocate the transaction accounts into one of the two groups based on the probabilistic data analysis score being above a predetermined threshold; and
contacting, by the computer-based system, the holders of the transaction accounts associated with at least one of the two groups.
